(19) United States
(12) Patent Application Publication
(10) Pub. No.: US 2002/0062746 A1
(43) Pub. Date: May 30, 2002

(54) Marking apparatus

(76) Inventors: Tetsuo Yano, Kanagawa (JP); Kazuyuki Funahashi, Kanagawa (JP); Tetsuya Kudoh, Kanagawa (JP)

Correspondence Address: FISH & RICHARDSON P.C., Suite 2800, 45 Rockefeller Plaza, New York, NY, 10111, US

(21) Appl. No.: 09/725,698

(22) Filed: Nov. 29, 2000

(30) Foreign Application Priority Data
Nov. 30, 1999 (JP) P. HEI. 11-341260

(51) Int. Cl. B41F 17/00; B41L 13/00; B05C 17/06; B05C 17/08

(52) U.S. Cl. 101/44; 101/41; 101/35; 101/126

(57) ABSTRACT

In the marking apparatus in which the marking tool is vibrated by piezoelectric body vibrator and characters are engraved onto the objective material, the detection means detects the amplitude of piezoelectric body vibrator as the DC signal, and the drive control means adjusts the frequency of the drive signal so that the level of the DC signal detected by detection means is within a predetermined range, and drives piezoelectric body vibrator, and by appropriately adjusting the frequency to drive piezoelectric body vibrator, drives piezoelectric body vibrator with a predetermined amplitude. Accordingly, because the amplitude of piezoelectric body vibrator can be kept within a constant range, the stable resonance can be conducted. Further, the resonance can be conducted without being influenced by the resonance frequency of the tool.

### BACKGROUND OF THE INVENTION

1. Field of the Invention

The present invention relates to a marking apparatus to stamp a production number or a product name onto the surface of a metallic or synthetic resin material part.

2. Description fo the Related Art

Conventionally, as a marking apparatus to engrave the production number or product name onto the surface of the metal or synthetic resins, an apparatus by which a marking tool is vibrated by a piezoelectric body vibrator and the surface of an objective material for processing is shaved, and the production number is engraved onto it, is used.

In the conventional marking apparatus, as an oscillation circuit to vibrate the piezoelectric body vibrator, a feedback type oscillation circuit and a phase synchronization loop type oscillation circuit are well known.

In the marking apparatus using the feedback type oscillation circuit, in the case where the piezoelectric body vibrator is driven by the constant current, when the mechanical Q value is high, because the amplitude of the piezoelectric body vibrator becomes the maximum at the mechanical resonance frequency, the resonance is conducted at this frequency. That is, the signal proportional to the vibration of the piezoelectric body vibrator in the mechanical resonance frequency is positively fed back to the amplifier, and the resonance system including the piezoelectric body vibrator is formed.

In the marking apparatus using the feedback type oscillation circuit, even when the resonance frequency of the resonance system including the piezoelectric body vibrator is changed, there is an advantage that it is always resonated at the resonance frequency.

Further, in the marking apparatus using the phase synchronization loop type oscillation circuit, as disclosed in JP-A-10-226196, the oscillation frequency of the oscillation circuit is controlled so that the phase difference of the drive voltage of the marking apparatus and the current flowing through the piezoelectric body vibrator becomes a predetermined value. Accordingly, there is an advantage that the marking apparatus can be driven by automatically following the resonance frequency or the appropriate frequency in the vicinity of that.

However, in the conventional oscillation circuit, there is a disadvantage that, in the feedback type oscillation circuit, when unnecessary resonance components such as the higher order of vibration components, exist in the resonance system including the oscillation circuit, the resonance condition is also satisfied in them, and the resonance occurs. Accordingly, there is a problem that the possibility that the unexpected resonance condition is generated, and the vibration with the extremely large amplitude is generated, thereby, the piezoelectric body vibrator is destroyed, exists.

Further, in the phase synchronization loop type oscillation circuit, because a range in which the resonance frequency of the tool can be followed, is narrow, it is necessary that the resonance frequency of the tool is made uniform, therefore, the high accuracy is required for the production of the tool. Further, there is a case that the resonance frequency is changed also due to the pressing force when the tool is pressed onto the objective material, therefore, there is a problem that the objective range for the processing of the apparatus is limited.

### SUMMARY OF THE INVENTION

An object of the present invention is to provide a marking apparatus by which the stable resonance can be conducted without being influenced by the resonance frequency of the tool.

The invention according to the first aspect is characterized in that: in a marking apparatus in which characters are stamped in an objective material by vibrating a marking tool by an piezoelectric body vibrator, the apparatus has: a detection means (f or example, a current signal detection circuit 13, and a rectifier circuit 14, in FIG. 1 and FIG. 4) for detecting the amplitude of the piezoelectric body vibrator as a DC signal; and a drive control means (for example, a drive circuit 12, limit value circuit 15, oscillation circuit 16, NAND gate 17, counter 18, D/F converter section 19) for driving the piezoelectric body vibrator by adjusting the frequency of a drive signal so that a level of the DC signal detected by the detection means is in a predetermined range, wherein, by appropriately adjusting the frequency for driving the piezoelectric body vibrator, the piezoelectric body vibrator is driven in the predetermined amplitude.

According to the invention of this first aspect, in the marking apparatus by which characters are engraved in the objective material by vibrating the marking tool by the piezoelectric body vibrator, the detection means detects the amplitude of the piezoelectric body vibrator as a DC signal, and the drive control means drives the piezoelectric body vibrator by adjusting the frequency of the drive signal so that a level of the DC signal detected by the detection means is in a predetermined range, and by appropriately adjusting the frequency to drive the piezoelectric body vibrator, the piezoelectric body vibrator is driven at a predetermined amplitude.

Further, as the invention according to the second aspect, in the marking apparatus according to the first aspect, the apparatus may also be structured such that the detection means has a current detection means (for example, a current signal detection circuit 13 in FIG. 1 and FIG. 4) for detecting the current flowing through the piezoelectric body vibrator, and a rectifier means (for example, a rectifier circuit 14 in FIG. 1 and FIG. 4) for rectifying the current detected by the current detection means and converting into the DC voltage signal, and the drive control means has: an adjusting means (for example, a limit value circuit 15, oscillation circuit 16, NAND gate 17, counter 18, in FIG. 1 and FIG. 4) for adjusting a level of the DC voltage signal corresponding to the level of the DC voltage signal, and outputting an adjustment signal; a conversion means (for example, a D/F conversion section 19 in FIG. 1 and FIG. 4) for converting the adjustment signal into a frequency signal showing a drive frequency of the piezoelectric body vibrator; and a drive means (for example, a drive circuit 12 in FIG. 1 and FIG. 4) for driving the piezoelectric body vibrator according to the frequency signal.

Further, as the invention according to the third aspect, in the marking apparatus according to the second aspect, the apparatus may also be structured such that the adjustment means has: a discrimination means (for example, a limit value circuit 15 in FIG. 1 and FIG. 4) for discriminating whether the level of the DC voltage signal is within a predetermined range, and when it is over the predetermined range, for outputting a preset signal, and when it is lower than the predetermined range, for outputting an operation signal, and when it is within the predetermined range, for outputting non-operation signal; an oscillation signal output means (for example, an oscillation circuit 16 in FIG. 1 and FIG. 4) for outputting an oscillation signal with a predetermined frequency; an output switching means (for example, a NAND gate 17 in FIG. 1 and FIG. 4) for digitizing the oscillation signal inputted from the oscillation signal output means and outputting a pulse signal, when the operation signal is inputted, and for outputting a signal of a predetermined level when the non-operation signal is inputted; and an adjustment signal output means (for example, a counter 18 in FIG. 1 and FIG. 4) for setting the output data to a predetermined value when the preset signal is inputted, and when the pulse signal is inputted, for subtracting the output value by 1 for every 1 pulse input, and outputting a digitized adjustment signal.

Further, as in the invention according to the fourth aspect, in the marking apparatus according to the third aspect of the invention, the adjustment signal output means may set the output data to a value in which a predetermined value is increased from the existing output data, when the preset signal is inputted, and the preset may also be conducted being adjusted to the existing condition.

Further, as in the invention according to the fifth aspect, in the marking apparatus according to the second aspect of the invention, the conversion means may also be structured such that it has: a digital•analog conversion means (for example, a D/A converter 19a in FIG. 4) for converting the adjustment signal into an analog signal; and a frequency signal output means (for example, a V/F converter 19b in FIG. 4) for outputting the frequency signal showing the driving frequency of the piezoelectric body vibrator, according to the analog signal converted by the digital•analog conversion means.

According to the invention of the first to fifth aspects, by appropriately determining a predetermined range of a DC signal, because the resonance is possible in a wide range of the frequency, the processing of the objective material can be conducted without being limited by the resonance frequency of the using tool.

Further, because it is not necessary that the resonance frequency of the tool using in the marking apparatus is made uniform, the high accuracy is not required for the production, thereby, the production cost of the tool is lowered. Therefore, the production cost of the marking apparatus can also be lowered, and the low cost marking apparatus can be provided.

Further, even when the frequency characteristic of the piezoelectric body vibrator is changed by pressing the tool onto the objective material, by adjusting the drive frequency, the piezoelectric body vibrator can be driven by an appropriate amplitude. Accordingly, the case in which the piezoelectric body vibrator is destroyed by driving the piezoelectric body vibrator by the excessive amplitude, can be prevented. Further, because it is not necessary that the pressing force onto the processing objective material is considered, a wide range of the objective materials can be processed.

Further, according to the invention of the fourth aspect, when the preset signal is outputted by the discrimination means, because the preset is conducted being adjusted to the existing condition, even when the frequency characteristic of the piezoelectric body vibrator is changed, and the amplitude is changed, the amplitude can be quickly adjusted to an adequate value.

### BRIEF DESCRIPTION OF THE DRAWINGS

FIG. 1 is a block diagram showing the structure of a marking apparatus 1 to which the present invention is applied.

FIG. 2 is a view showing the frequency characteristic of a piezoelectric body vibrator 11.

FIG. 3 is a view showing a signal inputted into a counter 18 and the signal outputted by the counter 18.

FIG. 4 is a view showing an example of the structure of a D/F conversion section 19 in FIG. 1.

FIG. 5A is a view showing the DC signal and the output voltage of the D/A converter 19a when the frequency characteristic is changed to the low frequency side.

FIG. 5B is a view showing the frequency characteristic of the piezoelectric body vibrator 11 when the frequency characteristic is changed to the low frequency side.

FIG. 6A is a view showing the DC signal and the output voltage of the D/A converter 19a when the frequency characteristic is changed to the high frequency side.

FIG. 6B is a view showing the frequency characteristic of the piezoelectric body vibrator 11 when the frequency characteristic is changed to the high frequency side.

### DETAILED DESCRIPTION OF THE PRESENT INVENTION

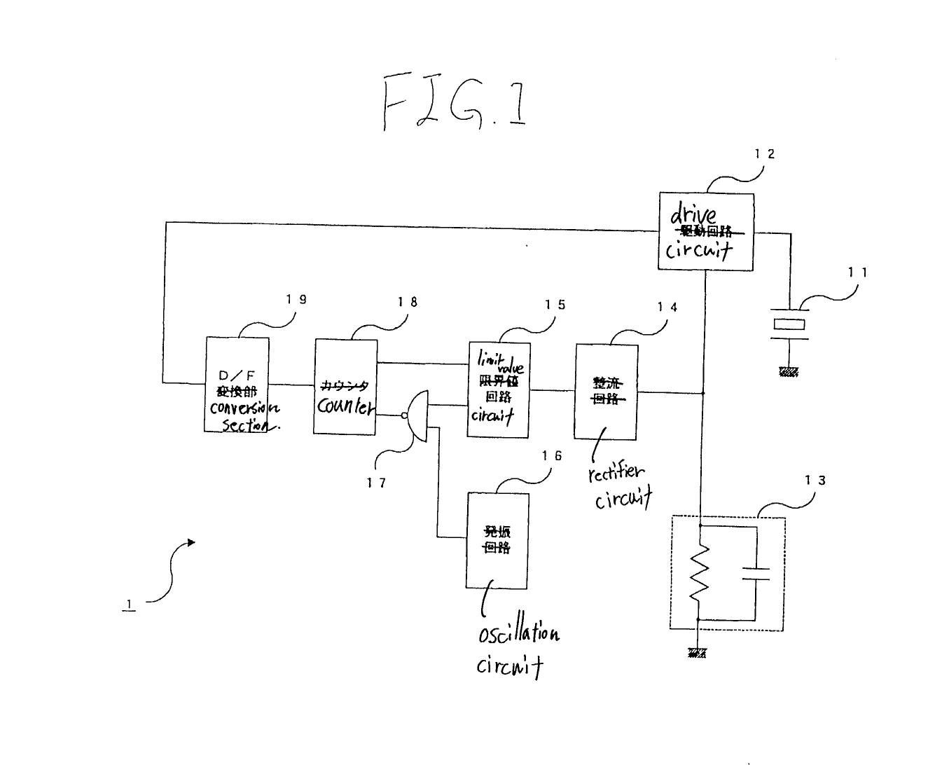

Referring to the drawings, an embodiment of the invention will be detailed below. From FIG. 1 to FIG. 5 are views showing the embodiment of a marking apparatus 1 to which the present invention is applied.

The marking apparatus 1 detects the current flowing through a drive circuit 12 by a current signal detection circuit 13 when the drive circuit 12 drives a piezoelectric body vibrator 11, and converts the current into the DC voltage by a rectifier circuit 14. Then, the upper limit value and the lower limit value are previously provided to the DC voltage, and when the DC voltage is not between the upper limit value and the lower limit value, the correction is conducted by a counter 18, and the voltage value after the correction is outputted. Next, a D/F (Digital/Frequency) conversion section 19 receives the voltage value after the correction, and outputs a signal showing a value of the frequency (hereinafter, called the frequency signal) corresponding to this voltage value.

Further, the frequency signal outputted by the D/F conversion section 19 is feedback-inputted into the drive circuit 12, and the drive circuit 12 drives the piezoelectric body vibrator 11 corresponding to the inputted frequency signal. Then, the current flowing through the drive circuit 12 is detected again by the current signal detection circuit 13. By repeating the above operations, because the drive frequency of the piezoelectric body vibrator 11 can be kept in a predetermined range, the marking apparatus 1 can keep the amplitude of the piezoelectric body vibrator 11 in a predetermined range, and can conduct the stable resonance. Further, the resonance can be conducted without being influenced by the resonance frequency of the tool.

Initially, the structure will be described. FIG. 1 is a block diagram showing the structure of a marking apparatus 1 to which the present invention is applied. In FIG. 1, the marking apparatus 1 is structured by: a piezoelectric body vibrator 11; drive circuit 12; current signal detection circuit 13; rectifier circuit 14; limit value circuit 15; oscillation circuit 16; NAND gate 17; counter 18; and D/F conversion section 19.

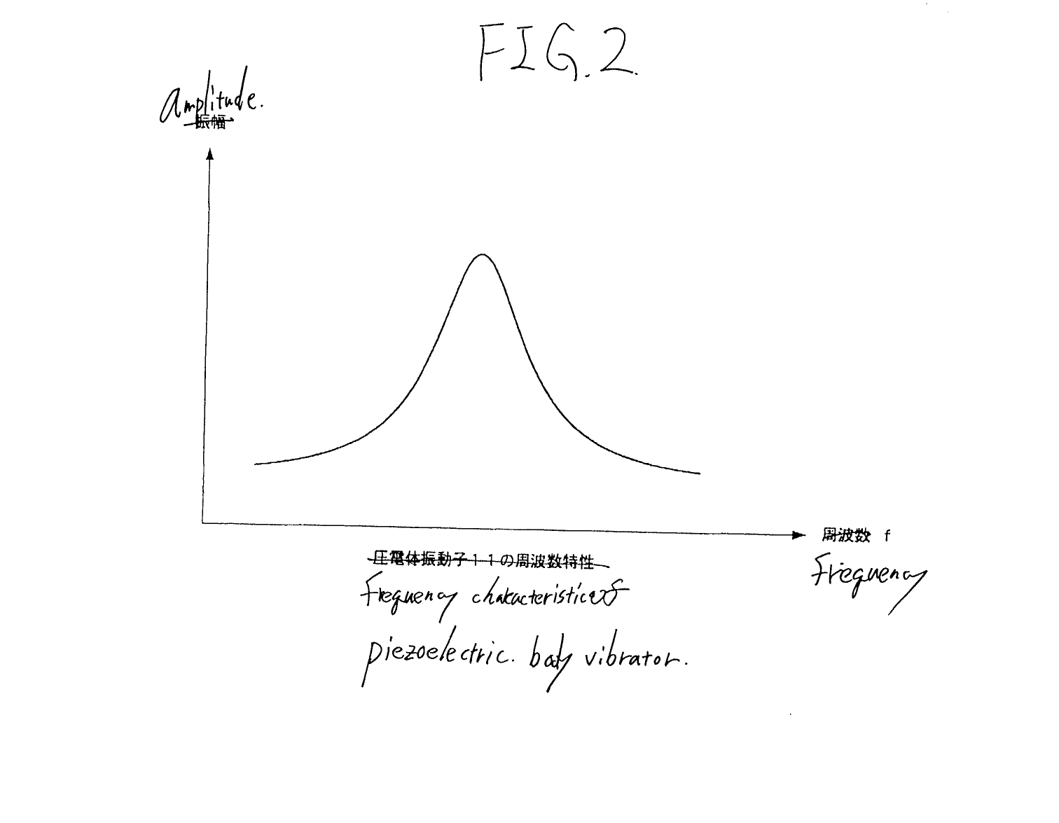

The piezoelectric body vibrator 11 vibrates at a predetermined frequency according to the drive signal outputted from the drive circuit 12, and vibrates the tool for shaving the surface of metals. Herein, referring to FIG. 2, the relationship between the frequency and the amplitude when the piezoelectric body vibrator 11 vibrates, will be described. FIG. 2 is a view showing the frequency characteristics of the piezoelectric body vibrator 11.

In FIG. 2, when the frequency vibrating the piezoelectric body vibrator 11 is changed, the amplitude becomes the maximum value at a specific frequency, and as the difference from the frequency at this time becomes large, the amplitude gradually attenuated. The frequency shown by the digital signal value set as the initial value of the counter 18 is set to the higher value than the frequency at which the piezoelectric body vibrator 11 shows the maximum amplitude. Accordingly, normally, the amplitude of the piezoelectric body vibrator 11 becomes large as the frequency is lowered.

The drive circuit 12 receives the frequency signal outputted from the D/F conversion section 19, and vibrates the piezoelectric body vibrator 11 at the frequency shown by the frequency signal.

The current signal detection circuit 13 detects the current flowing though the drive circuit 12 as the current signal, and outputs the current signal to the rectifier circuit 14.

The rectifier circuit 14 converts the current signal outputted from the current signal detection circuit 13 into the predetermined DC voltage corresponding to the largeness of the current, and outputs it.

The limit value circuit 15 compares the DC voltage outputted from the rectifier circuit 14 to the upper limit value and the lower limit value which are previously set, and when the DC voltage is more than the upper limit value, outputs the preset signal to preset the counter 18. Further, when the DC voltage is lower than the lower limit value, the limit value circuit 15 outputs the high level output signal “H” to the NAND gate 17. Further, when the DC voltage is a value between the upper limit value and the lower limit value, the limit value circuit 15 outputs the low level output signal “L” to the NAND gate 17.

The oscillation circuit 16 always oscillates at a predetermined frequency, and generates the high level output signal “H” or the low level output signal “L”. Then, it outputs the output signal (hereinafter, called oscillation signal) to the NAND gate 17.

The NAND gate 17 outputs the high level output signal “H” or the low level output signal “L” corresponding to the output signal outputted from the limit value circuit 15 and the value of the oscillation signal outputted from the oscillation circuit 16.

In the counter 18, the preset signal outputted from the limit value circuit 15 is inputted into a preset input terminal, and the output signal outputted from the NAND gate 17 is inputted into a clock input terminal. Then, when these signals are inputted into each input terminal, the counter 18 outputs a predetermined digital signal.

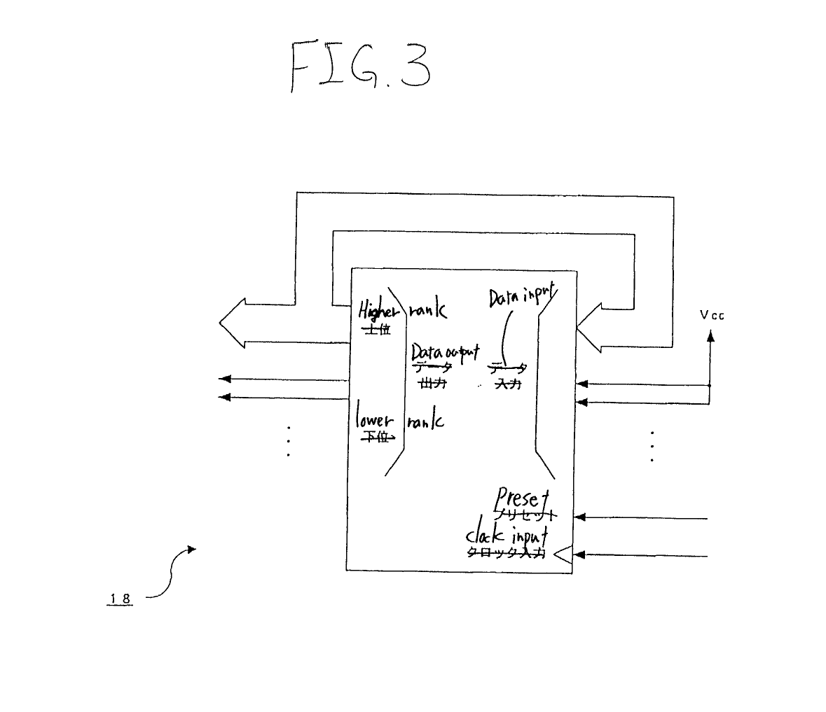

Herein, referring to FIG. 3, the signal which is inputted into and outputted from the counter 18, will be described. FIG. 3 is a view showing the signal inputted into the counter 18 and the signal outputted from the counter 18.

In the counter 18, in the initial condition, all of the output bits are set to “1”. Then, every time when the output signal of the NAND gate 17 to be inputted into the clock input terminal is changed from “H” to “L”, the digital signal is subtracted by each 1, and outputted. Further, when the preset signal is inputted into the preset input terminal, the higher-rank bits of a predetermined number of the digital signal are made the input values as they are, and “1” is made the input value for all of the remaining lower-rank bits, and the digital signal of the counter 18 is preset. Accordingly, when the preset signal is received, the counter 18 outputs the larger value than the existing digital signal.

The D/F conversion section 19 receives the digital signal outputted from the counter 18, converts it to the frequency corresponding to the relevant digital signal, and outputs the frequency signal showing the relevant frequency.

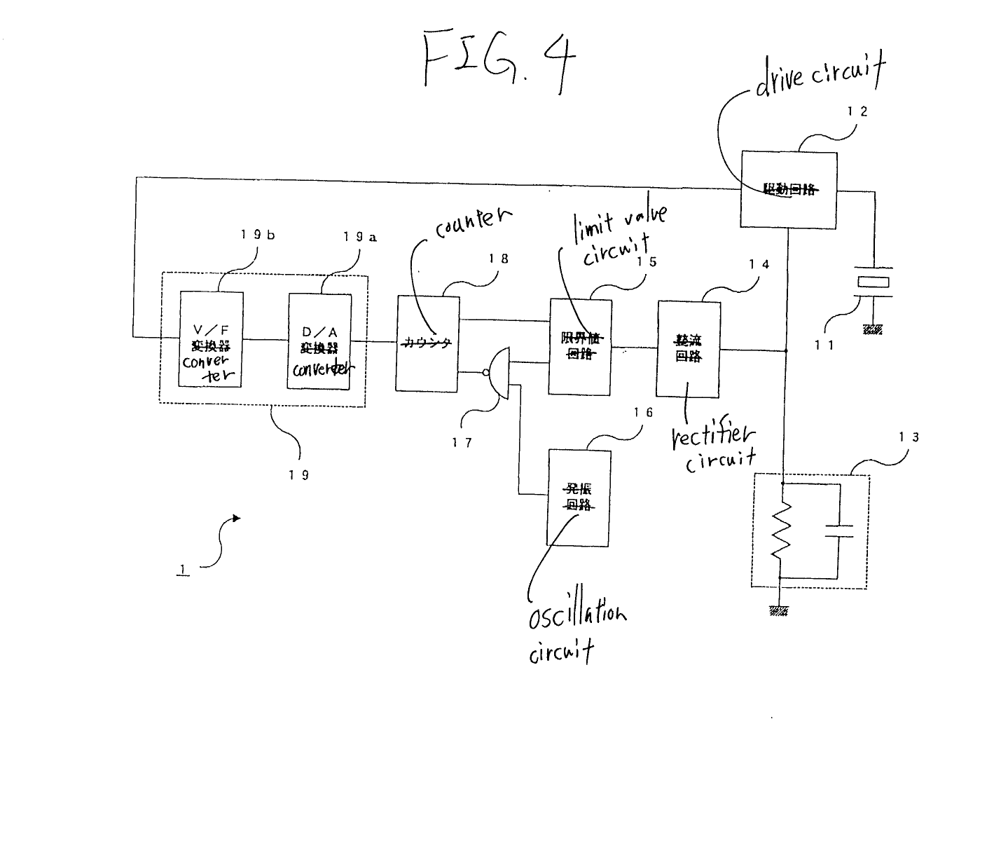

Herein, referring to FIG. 4, the structure of the D/F conversion section 19 will be described below. FIG. 4 is a view showing an example of the structure of the D/F conversion section 19 in FIG. 1. In this FIG. 4, the D/F conversion section 19 is structured by a D/A (Digital/Analog) converter 19a and a V/F (Voltage/Frequency) converter 19b.

In FIG. 4, the D/A converter 19a receives the digital signal outputted from the counter 18, and converts the digital signal into the analog signal, and outputs it as a voltage value. Further, the V/F converter 19b receives the voltage value outputted from the D/A converter 19a, and generates and outputs a signal showing the frequency (frequency signal) corresponding to the voltage value.

Next, operations will be described. Incidentally, the D/F conversion section 19 will be described as the structure as shown in FIG. 4.

In the marking apparatus 1, as an initial condition, “1” is set to all the digital signals outputted from the counter 18.

In this case, the digital signal outputted from the counter 18 is the maximum value, and the digital signal showing this maximum value is outputted to the D/F conversion section 19. Then, the D/F conversion section 19 converts the value shown in the digital signal into the corresponding frequency, and outputs it as the frequency signal.

When the drive circuit 12 receives the frequency signal outputted from the D/F conversion section 19, the drive circuit 12 vibrates the piezoelectric body vibrator 11 at the frequency shown in the frequency signal. At this time, the current flowing into the piezoelectric body vibrator 11 through the drive circuit 12 is detected by the current signal detection circuit 13. Then, this current is converted into the DC voltage in the rectifier circuit 14, and outputted to the limit value circuit 15.

Next, the limit value circuit 15 compares the DC voltage outputted from the rectifier circuit 14 to the upper limit value and the lower limit value. Herein, the initial value of the counter 18 shows the maximum value of the digital signal. In this case, the frequency at which the piezoelectric body vibrator 11 is driven, is the higher value than the frequency which is the lower limit value of the DC voltage. That is, the DC voltage inputted into the limit value circuit 15 is lower than the lower limit value. Accordingly, the high level output signal “H” is outputted from the limit value circuit 15 to the NAND gate 17.

The NAND gate 17 outputs “L” in the case where the oscillation signal outputted from the oscillation circuit 16 is “H”, when the output signal “H” is outputted from the limit value circuit 15, and outputs “H” when the oscillation signal is “L”. These “H” and “L” signals outputted from the NAND gate 17 are inputted into the clock input terminals of the counter 18. Then, every time when this signal is changed from “H” to “L”, the value shown by the digital signal is subtracted by each “1”, and outputted from the counter 18 to the D/A converter 19a as the digital signal.

The D/A converter 19a converts the digital signal to the analog signal when the digital signal is outputted from the counter 18. Then, the analog signal is outputted to the V/F converter 19b as the signal showing the voltage value. Then, the V/F converter 19b converts the value shown in the analog signal into the corresponding frequency, and outputs it to the drive circuit 12 as the frequency signal.

When the resonance frequency of the marking apparatus 1 is constant, the operations described above, are repeated until the DC signal becomes a value between the upper limit value and the lower limit value, and when the steady-state is obtained, the marking apparatus 1 conducts the stable resonance.

Next, operations when the frequency characteristic of the piezoelectric body vibrator 11 is changed due to the change of the pressure pressed onto the objective material, will be described.

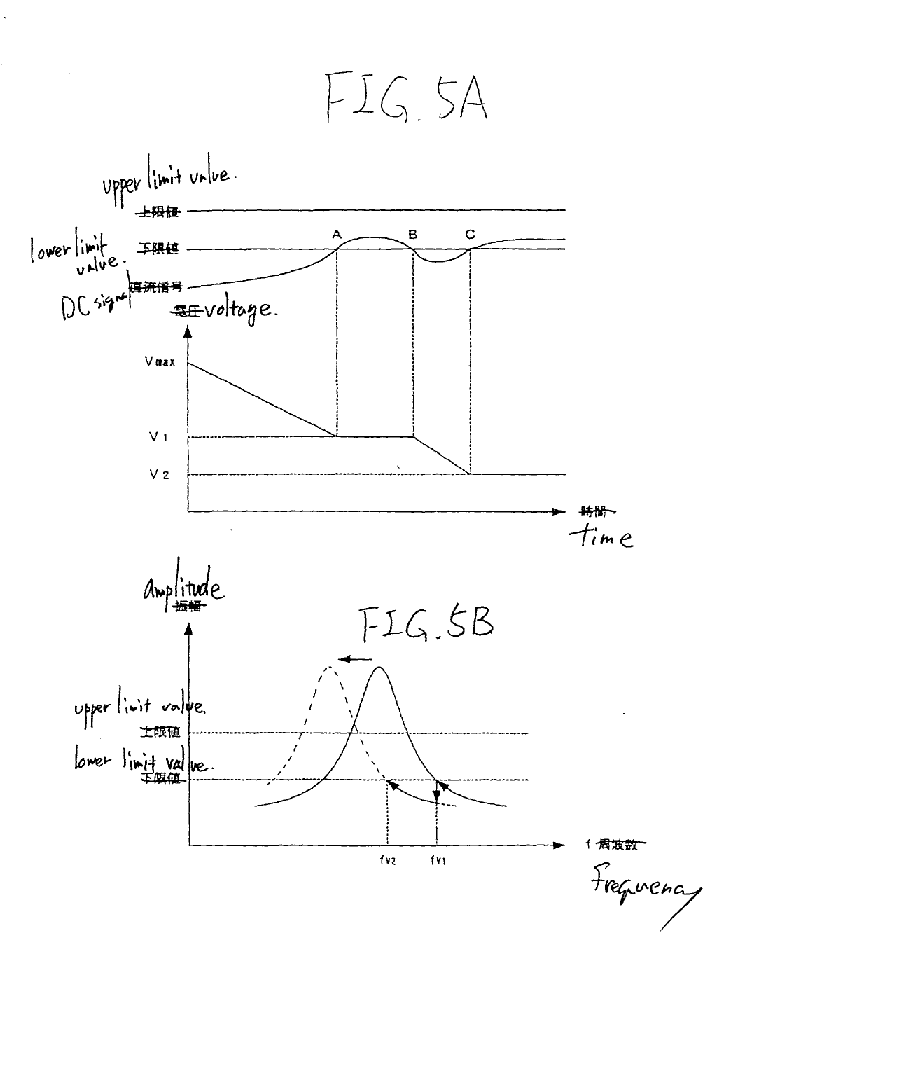

Initially, a case where the frequency characteristic is changed to the low frequency side, will be described. FIG. 5A is a view showing the DC signal and an output voltage of the D/A converter 19a, when the frequency characteristic is changed to the low frequency side. Further, FIG. 5B is a view showing the frequency characteristic of the piezoelectric body vibrator 11 when the frequency characteristic is changed to the low frequency side.

In FIG. 5A, the marking apparatus 1 adjusts the resonance frequency from the initial condition, and at the point A, it is in the steady-state. At this time, the output voltage of the D/A converter 19a is V1. Further, in FIG. 5B, the drive frequency of the piezoelectric body vibrator 11 is fV1.

After that, when the frequency characteristic of the piezoelectric body vibrator 11 changes to the low frequency side, the decrease of the amplitude of the piezoelectric body vibrator 11, that is, the decrease of the current flowing into the piezoelectric body vibrator 11 through the drive circuit 12 occurs.

Then, the lowered current is detected by the current signal detection circuit 13, and at the point B, the DC signal is lower than the lower limit value. Then, the marking apparatus 1 increases the DC signal again and adjusts the resonance frequency, and when the DC signal is over the lower limit value at the point C, becomes the steady-state again. In this case, the output voltage of the D/A converter 19a becomes V2. Further, in FIG. 5B, the drive frequency of the piezoelectric body vibrator 11 becomes fV2, and according to the frequency characteristic after the change, the piezoelectric body vibrator 11 is driven at an appropriate frequency.

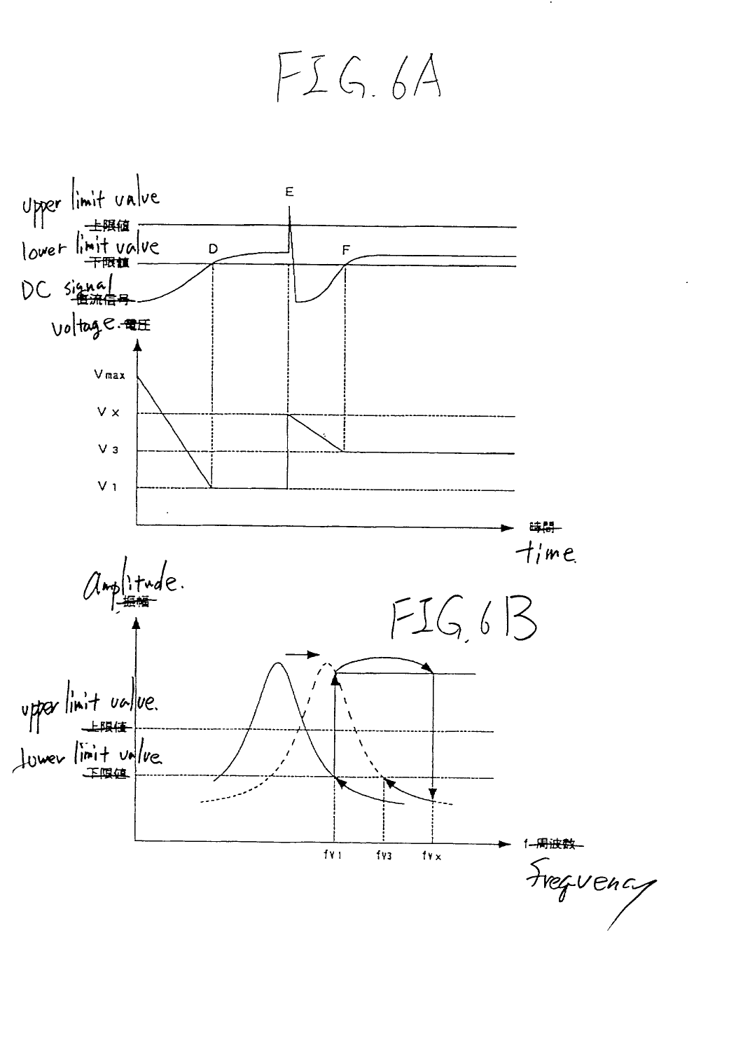

Next, a case where the frequency characteristic is changed to the high frequency side, will be described. FIG. 6A is a view showing the DC signal and the output voltage of the D/A converter 19a when the frequency characteristic is changed to the high frequency side. Further, FIG. 6B is a view showing the frequency characteristic of the piezoelectric body vibrator 11 when the frequency characteristic is changed to the high frequency side.

In FIG. 6A, the marking apparatus 1 adjusts the resonance frequency from the initial condition, and at the point D, becomes the steady-state. In this case, the output voltage of the D/A converter 19a becomes V1. Further, in FIG. 6B, the drive frequency of the piezoelectric body vibrator 11 becomes fV1.

After that, when the frequency characteristic of the piezoelectric body vibrator 11 is changed to the high frequency side, the amplitude of the piezoelectric body vibrator 11 is increased, that is, the current flowing into the piezoelectric body vibrator 11 through the drive circuit 12 is increased.

Then, the increased current is detected by the current signal detection circuit 13, and at the point E, the DC signal is over the upper limit value. Herein, the marking apparatus 1 presets the counter 18. That is, the output values in their original condition, are made to the input values to the predetermined number of higher-rank bits in the digital signal outputted from the counter 18, and “1” is made an input value to all of the remaining lower-rank bits. Accordingly, the drive frequency of the piezoelectric body vibrator 11 is the higher frequency by a predetermined value than the existing frequency. In this case, the output voltage of the D/A converter 19a becomes Vx. Further, in FIG. 6B, the drive frequency of the piezoelectric body vibrator 11 becomes fVx, and the DC signal is lower than the lower limit value.

After that, the DC signal is increased again and the resonance frequency is adjusted, and when the DC signal is over the lower limit value at the point F, the marking apparatus 1 becomes the steady-state again. In this case, the output voltage of the D/A converter 19a becomes V3. Further, in FIG. 6B, the drive frequency of the piezoelectric body vibrator 11 becomes fV3, and the piezoelectric body vibrator 11 is driven at the appropriate frequency according to the frequency characteristic after the change.

As described above, the marking apparatus 1 in the present embodiment, by appropriately setting the upper limit value and the lower limit value, because the resonance can be conducted in a wide range of the frequency, the objective material can be processed without being limited by the resonance frequency of the using tool.

Further, because it is not necessary that the resonance frequency of the tool for use in the marking apparatus 1 is made uniform, the high accuracy is not required for the production of the tool, thereby, the production cost of the tool is lowered. Accordingly, the production cost of the marking apparatus 1 can also be decreased, and the inexpensive marking apparatus can be provided.

Further, when the frequency characteristic of the resonance system including the piezoelectric body vibrator 11 is changed, the marking apparatus 1 in the present embodiment automatically adjusts the DC voltage outputted from the rectifier circuit 14 so that it becomes a value between the lower limit value and the upper limit value, and changes the drive frequency of the piezoelectric body vibrator 11.

Thereby, even when the frequency characteristic is changed by pressing the tool onto the processing objective material, by adjusting the drive frequency, the piezoelectric body vibrator 11 can be driven with the appropriate amplitude. Accordingly, a case can be prevented that the piezoelectric body vibrator 11 is driven with the excessive amplitude, and the piezoelectric body vibrator 11 is broken. Further, because it is not necessary that the pressing pressure onto the processing objective material is considered, a wide range of the processing objective materials can be processed.

Further, because the oscillation circuit 16 can use a circuit of the oscillation frequency of several tens kHz, even when the frequency characteristic of the drive system is changed, the drive frequency of the piezoelectric body vibrator 11 can be quickly adjusted to the predetermined range. Accordingly, the marking apparatus by which the stable resonance can be obtained, can be provided.

Incidentally, in the present embodiment, the processing by which the current flowing into the drive circuit 12 is detected, and the drive frequency of the piezoelectric body vibrator 11 is adjusted according to the current, is conducted by the hardware such as the rectifier circuit 14, and the limit value circuit 15, however, the same function may be realized by arithmetically processing the current.

Further, the D/F conversion section 19 is structured by the D/A converter 19a and the V/F converter 19b, however, in the case where the function by which the digital signal is converted into the frequency signal, can be realized, another structure may be used.

According to the invention of the first to fourth aspects, by appropriately determining a predetermined range of the DC signal, because the resonance can be conducted at a wide range of the frequency, the objective material can be processed without being limited by the resonance frequency of the using tool.

Further, because it is not necessary that the resonance frequency of the tool used for the marking apparatus is made uniform, the high accuracy is not required for the production, thereby, the production cost of the tool is lowered. Therefore, the cost for producing the marking apparatus can also be lowered, thereby, the low cost marking apparatus can be provided.

Further, even when the frequency characteristic of the piezoelectric body vibrator is changed by pressing the tool onto the objective material, by adjusting the drive frequency, the piezoelectric body vibrator can be driven with the appropriate amplitude. Accordingly, the case where the piezoelectric body vibrator is broken by driving the piezoelectric body vibrator with the excessive amplitude, can be prevented. Further, because it is not necessary that the pressing pressure onto the processing objective material is considered, a wide range of the objective materials can be processed.

What is claimed is:

1. A marking apparatus for stamping characters in an objective material, the marking appratus comprising:
a piezoelectric body vibrator for vibrating a marking tool
a detector for detecting an amplitude of the piezoelectric body vibrator as a DC signal; and
a drive controllor for driving the piezoelectric body vibrator by adjusting a frequency of a drive signal so that a level of the DC signal detected by the detector is in a predetermined range,
wherein the frequency for driving the piezoelectric body vibrator is approximately adjusted to drive the piezoelectric body vibrator in the predetermined amplitude.

2. The marking apparatus according to claim 1, wherein the detector includes:
a current detector for detecting a current flowing through the piezoelectric body vibrator; and
a rectifier for rectifying the current detected by the current detector and for converting the current into a DC voltage signal, and
wherein the drive controllor includes:
an adjustor for adjusting a DC voltage signal level corresponding to a level of the DC voltage signal to output the adjusted signal;
a convertor for converting the adjusted signal into a frequency signal indicating a drive frequency of the piezoelectric body vibrator; and
a drive section for driving the piezoelectric body vibrator according to the frequency signal.

3. The marking apparatus according to claim 2, wherein the adjustor includes:
a discriminator for discriminating whether the level of the DC voltage signal is within the predetermined range, the discriminator for outputting a preset signal when the level thereof is over the predetermined range, the discriminator for outputting an operation signal when the level thereof is lower than the predetermined range, the discriminator for outputting a non-operation signal when the level thereof is within the predetermined range;
an oscillation signal output section for outputting an oscillation signal with a predetermined frequency;
an output switching section for digitizing the oscillation signal inputted from the oscillation signal output section and outputting a pulse signal when the operation signal is inputted, the ourput switching section for outputting a signal of a predetermined level when the non-operation signal is inputted; and
an adjustment signal output section for setting the output data to a predetermined value when the preset signal is inputted, the adjustment signal output section for subtracting the output value by 1 for every 1 pulse input and outputting a digitized adjustment signal when the pulse signal is inputted.

4. The marking apparatus according to claim 3, wherein when the preset signal is inputted, the adjustment signal output section sets the output data to a value which is increased by a predetermined value from the existing output data, and the preset is conducted being adjusted to the existing condition.

5. The marking apparatus according to claim 2, wherein the conversion means has:
a digital/analog converter for converting the adjustment signal into an analog signal; and
a frequency signal output section for outputting the frequency signal indicating the driving frequency of the piezoelectric body vibrator, according to the analog signal converted by the digital/analog convertor.
